(19) United States
(12) Patent Application Publication
(10) Pub. No.: US 2005/0115795 A1
(43) Pub. Date: Jun. 2, 2005

(54) Utility vehicle body

(75) Inventor: George Bailey, Byron, IL (US)

Correspondence Address: Timothy D. Smith;Brouse McDowell, Suite #500, 388 South Main Street, Akron, OH, 44311-4407, US

(73) Assignee: SWENSON SPREADER COMPANY

(21) Appl. No.: 10/981,221

(22) Filed: Nov. 4, 2004

Related U.S. Application Data
(60) Provisional application No. 60/517,238, filed on Nov. 4, 2003.

(51) Int. Cl. A01G 1/00

(52) U.S. Cl. 198/300

(57) ABSTRACT

A landscaper body provides for multiple functions for a contractor integrated into one unit. The landscaper body has a bed defined by a front, rear, and two sides extending between the front and rear. Four corner posts are positioned about the truck bed to enable various components to be securely attached to the landscaper body. The present invention is a cross-member-less design to reduce the weight of the body. The landscaper body utilizes a hoist to provide vertical movement to the front of the body to achieve a dumping effect. The landscaper body also utilizes a conveyor system to discharge material while the landscaper body is in a horizontal position.

This application claims priority to U.S. Provisional patent application Ser. No. 60/517,238 filed on Nov. 4, 2003.

### 1. BACKGROUND OF THE INVENTION

A. Field of Invention

This invention is directed to apparatus and methods relating to an improved landscaper body having modular components so as to provide multiple functions with one unit.

### 2. BRIEF HISTORY

Currently, landscapers use existing bodies and make their own adaptation. Because landscapers are providing more services, such as snow and ice removal, lawn and garden services, and general maintenance services, capital investment is expensive to buy individual units for each of these applications. Further, time is wasted by contracts because of material handling. More specifically, landscaper bodies known in the art dump material in a selected location and then the material needs to be moved to a wheel barrow before it can be spread. As such, there is a need in the art for a landscaper body that is adapted to provide multiple applications within one easy to install unit.

### 3. SUMMARY OF THE INVENTION

A new and improved landscaper body is designed utilizing modular units for various applications. It is one object of the present invention to provide a landscaper body which has multiple integrated applications including without limitation mulching, hauling dirt, cutting grass, gathering leaves, shredding leaves, spreading, multiple discharge points, towing, dumping, and spreading.

It is yet another object to provide a landscaper body that is adapted to discharge material from all sides of the landscaper body.

It is yet another object of the present invention to provide a landscaper body that is rugged and durable.

It is yet another object of the present invention to provide a landscaper body that has all operating functions and options built into the unit.

It is yet another object of the present invention is to provide a landscaper body which is easy to customize options.

Further, another object of the present invention is to provide a landscaper body that is adaptable to fit small and medium size GVW vehicles.

Still yet, another object of the present invention is to provide a landscaper body that is fast and easy to install on a sub-frame.

Still, another object of the present invention is to provide a landscaper body that includes a water hose attachment.

Still yet, another object of the present invention is to provide a water tank to provide a main storage unit for liquids or fertilizer.

Further, another object of the present invention is to provide a landscaper body having a water tank and could be used to fill hand held units.

Another object of the present invention is to provide a landscaper body having a gas powered generator that is able to fit into the unit as an accessory.

Further, another object of the present invention is to provide mulch holding stacked sides.

Further, another object of the present invention is to provide a storage tool box behind the cab which may be integrated with the landscaper body to hold hoses, hand tools, rope, but not limited thereto.

Still yet, another object of the present invention is to provide over-cab wheelbarrow storage.

Further, another object of the present invention is to provide a built in ladder.

Another option of the present invention is to provide a bolt on cab shield.

Further, another object of the present invention is to provide a landscaper body having a leaf shredder operatively connected to the back gate to provide for easy on and off leave shredding capability.

Further, another object of the present invention is to provide a landscaper body having a tow hitch to pull a leaf/wood shredder or a flat trailer.

Another object of the present invention is to provide a landscaper body having hydraulic attachments.

Further, another object of the present invention is to provide a landscaper body having an air compressor with air driven attachments.

Still yet, another object of the present invention is to provide a floor adapted to be wide enough to accommodate two skids to fit side by side.

Still, another object of the present invention is to provide a landscaper body that loads and spreads salt, sand, dirt, and mulch to eliminate multiple units which do the same job to save money.

Another object of the present invention is to provide a landscaper body with an integrated spreader.

Another object of the present invention is to provide a landscaper body having fold down sides that are flush and that is flat bed capable.

Further, another object of the present invention is to provide a 10-gauge heavy duty floor which is tough for multi-purpose use, durable, and long-lasting.

Another object of the present invention is to provide a conveyor which is easy to use, durable and quick and easy and saves time.

Further, another object of the present invention is to provide a sloping floor to provide for easier and quicker material movement.

Another object of the present invention is to provide a landscaper body with a double acting tailgate having a top pivot for dumping and a bottom pivot for folding the tail gate out of the way.

Further, another object of the present invention is to provide a mulch door/tailgate for direct spreading which provides for easy filling of wheelbarrows and direct dumping, which results in time and economical savings.

Further, another object of the present invention is to provide a landscaper body which is easy to manufacture and easy to use while being cost effective.

Further, another object of the present invention is to provide a utility vehicle storage body, comprising: a frame, a generally planar frame bed juxtaposed to the frame, a front body wall;
a rear body wall;
at least a first side operatively connected with respect to the frame, the at least a first side extending substantially along the entire length of the frame bed;
wherein the frame bed, front body wall, rear body wall and at least a first side define a body storage region; and,
at least a first frame bed member extending substantially along the entire length of the frame bed, the at least a first frame bed member being pivotally attached with respect to the frame, wherein the at least a first frame bed member is selectively moveable between a first minimum position interior to the body storage region and a second maximum position exterior to the body storage region.

Further, another object of the present invention is to provide a landscaper body further comprising:
a conveyor having first and second ends, the conveyor being operatively received within the body storage region, the conveyor extending proximate to and at least partially along the length of the frame bed.

Further, another object of the present invention is to provide a landscaper body wherein the conveyor extends substantially along the entire length of the frame bed.

Further, another object of the present invention is to provide a landscaper body wherein the rear body wall includes at least a first discharge opening, and,
wherein the first end of the conveyor is juxtaposed to the at least a first discharge opening.

Further, another object of the present invention is to provide a landscaper body wherein the at least a first discharge opening includes a moveable door, and,
wherein the door is selectively moveable between at least first and second open positions.

Further, another object of the present invention is to provide a landscaper body further comprising:
a spreader operatively connected with respect to the frame for use in the spreading associated materials from the storage body.

Further, another object of the present invention is to provide a landscaper body wherein the rear body wall has first and second sides, and,
wherein the first side is pivotally connected with respect to the frame, and,
wherein the second side is selectively releaseably attached with respect to the frame.

Further, another object of the present invention is to provide a landscaper body further comprising:
a hoist operatively connected to the storage body for use in raising the dump body with respect to an associated vehicle.

Further, another object of the present invention is to provide a landscaper body including:
a frame; a generally planar frame bed juxtaposed to the frame; a front body wall;
a rear body wall; and,
at least a first side wall operatively connected with respect to the frame, the at least a first side wall extending substantially along the entire length of the frame bed, wherein the cross section of the at least a first side wall forms an angle A with respect to the cross section of the frame bed, wherein the at least a first side wall is selectively adjustable such that angle A is substantially between 0 and 180.

Another object of the present invention is to provide a landscaper body further comprising:
a conveyor having first and second ends, the conveyor being operatively connected with respect to the frame, the conveyor extending proximate to and at least partially along the length of the frame bed.

Another object of the present invention is to provide a landscaper body wherein the rear body wall includes at least a first discharge opening, and,
wherein the first end of the conveyor is juxtaposed to the at least a first discharge opening.

Another object of the present invention is to provide a utility vehicle storage body, including a spreader operatively connected with respect to the frame for use in the spreading associated materials from the storage body.

Another object of the present invention is to provide a landscaper vehicle comprising:
a vehicle frame; at least a first ground engaging wheel rotatably connected with respect to the vehicle frame; an engine operatively received by the vehicle frame for use providing locomotion to the vehicle;
a utility storage body operatively connected to the vehicle frame, the utility storage body, comprising:
a body frame;
a generally planar body frame bed juxtaposed to the body frame;
a front body wall;
a rear body wall;
at least a first side wall operatively connected with respect to the frame, the at least a first side wall extending substantially along the entire length of the frame bed;
wherein the frame bed, front body wall, rear body wall and at least a first side define a body storage region; and,
at least a first frame bed member extending substantially along the entire length of the frame bed, the at least a first frame bed member being pivotally attached with respect to the frame, wherein the at least a first frame bed member is selectively moveable between a first minimum position interior to the body storage region and a second maximum position exterior to the body storage region.

Another object of the present invention is to provide a landscaper vehicle further comprising;
a hoist operatively connected between the vehicle frame and the body frame.

Another object of the present invention is to provide a landscaper vehicle further comprising:
a conveyor having first and second ends, the conveyor being operatively connected with respect to the body frame, the conveyor extending proximate to and at least partially along the length of the frame bed.

Another object of the present invention is to provide a landscaper vehicle wherein the rear body wall includes at least a first discharge opening, and,
wherein the first end of the conveyor is juxtaposed to the at least a first discharge opening.

Another object of the present invention is to provide a landscaper vehicle further comprising:
a spreader operatively connected with respect to the frame for use in the spreading associated materials from the storage body.

Still other benefits and advantages of the invention will become apparent to those skilled in the art to which it pertains upon a reading and understanding of the following detailed specification.

### 4. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a utility body.

FIG. 2 is a perspective view of a utility body.

### 5. DESCRIPTION OF THE PREFERRED EMBODIMENT

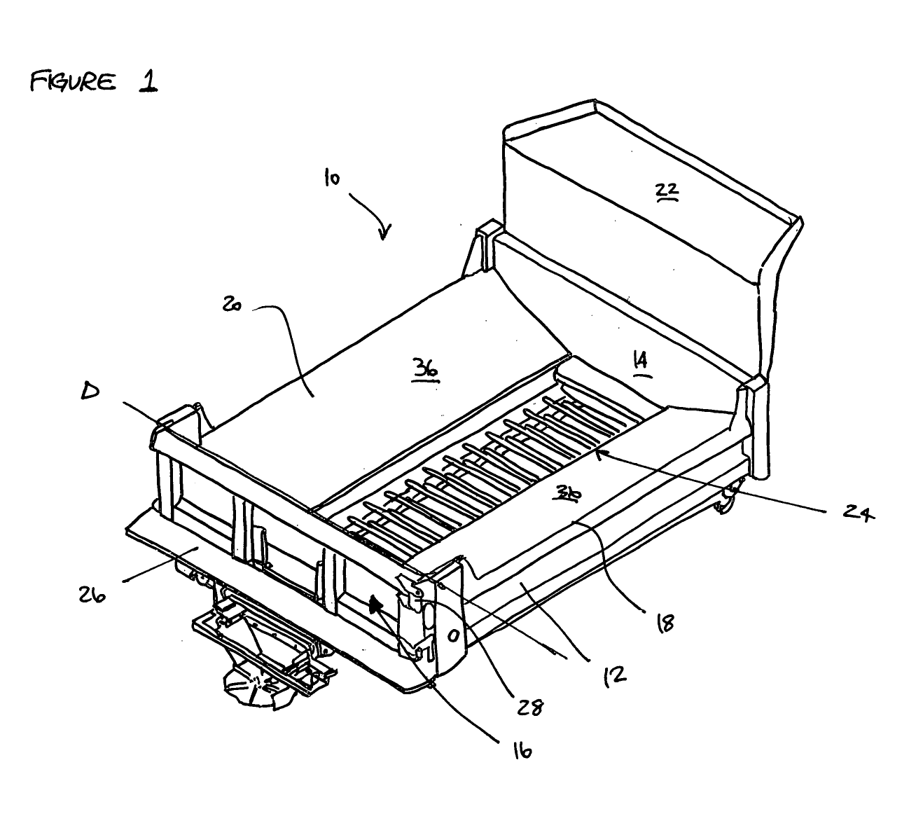

Referring now to the drawings wherein the showings are for purposes of illustrating a preferred embodiment of the invention only and not for purposes of limiting the same, FIG. 1 shows a new and improved landscaper body 10. The landscaper body is designed for everyday use and for multiple services including the spreading of mulch, dirt, sod, and shrubs. It may have the ability to cut grass, gather leaves, and provide general purposes hauling such as big branches. It may also be used to spread material such as salt, sand, rock, or fertilizer. Another feature is that it has the ability to discharge from all sides of the landscaper body to provide ease of use. As will be described below, plenty of storage for tools is provided. It would be easy enough to use and provide flexibility to provide towing, dumping, and spreading abilities while being rugged and durable. It will be easy to use as a multi-purpose unit since everything may be integrated therein. It is easy to customize options and adapt to small and medium size GVW vehicles. The body 10 may be mounted on a sub-frame for easy attachment to an existing vehicle. In one embodiment of the invention, the sub-frame of the body 10 can be bolted onto an existing vehicle.

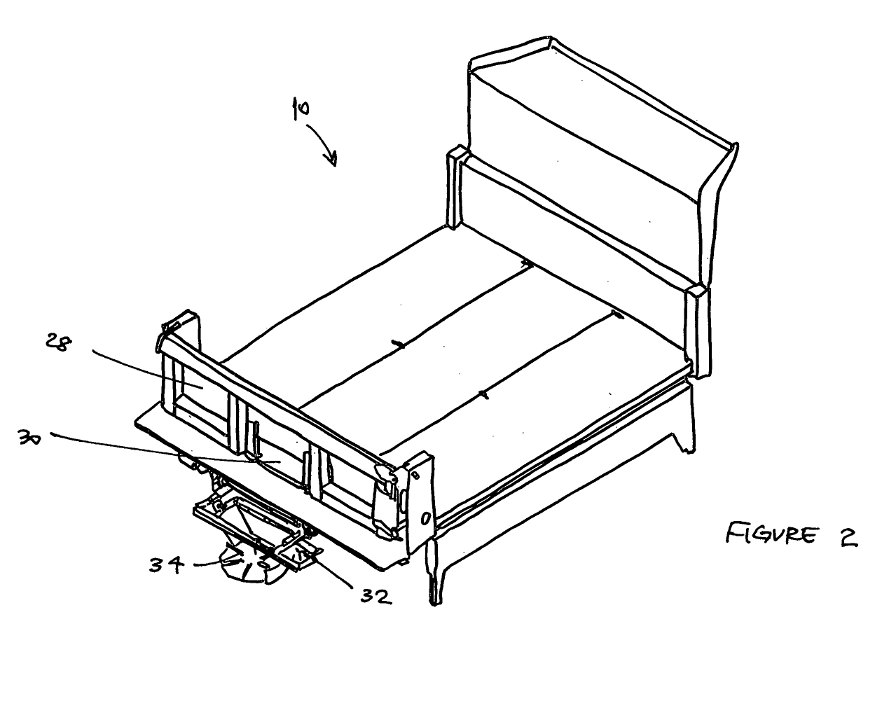

With respect to FIGS. 1 and 2, the landscaper body 10 comprises a frame 12. The landscaper body 10 further comprises a bed 11 defined by a front 14, rear 16, and two sides 18, 20 extending between the front 14 and rear 16. Four corner posts are positioned about the truck bed 11 to enable various components to be securely attached to the landscaper body, which will be described in detail below. The present invention is a cross-member-less design to reduce the weight of the body 10. A cab shield 22 may be positioned at the front of the body 12 to provide protection to the cab of the vehicle utilizing the body 10. The cab shield 22 covers the gap between the front of the landscaper body 10 and partially over the top of the vehicle. As such, when material is dumped into the bed of the landscaper body, anything that misses the target falls against the cab shield 22. It is also contemplated to be within the scope of the present invention to have a telescopic cylinder, preferably located towards the front of the landscaper body 10.

The landscaper body has various features. The landscaper body 10 further comprises a hoist, which may be a hydraulic actuator, operatively connected to the body 10 towards the front 14. The hoist raises the front of the landscaper body 10 to enable a dump body effect. Accordingly, the operator can discharge mulch or other material while the body 10 maintains an angle relative to a horizontal plane. With specific reference to FIG. 1, a center discharge conveyor system 24 is shown. The conveyor system 24 enables the movement of material in the horizontal position such that the hoist need not be utilized. The presence of the conveyor system 24 enables the landscaper body 10 to provide multiple functions for the operator. For example, when mulch is being spread during landscaping, normally, the mulch is dumped from a truck into one location, and the contractor must shovel it into a wheel barrow to bring it to the desired destination. With the present invention, the contractor can bring the wheel barrow straight to the conveyor and fill the wheel barrow so avoid excess material handling, thus, increase efficiency. The conveyor may be 34 inches in width; however, any size may be chosen with sound engineering judgment. Other features include a direct drive conveyor motor to eliminate the need for a gear box and the wear of parts. However, any type of conveyor driver may be used as chosen with sound engineering judgment.

With continuing reference to FIGS. 1 and 2, the landscaper body 10 may further comprise a tail gate 26. The tailgate 26 may have three different modes of operation. First, the tailgate 26 may swing open from one side to the other and latch into the side of the body. In this mode of operation, the tailgate 26 pivots about a hinge 28. Second, the tailgate 26 would also be able to pivot about axis D to provide for material to be discharged from the truck bed 11 through a dumping action. Third, the tailgate 26 will be able to fold down into the floor of the truck bed 11 through a lower pivot axis. With continuing reference to FIGS. 1 and 2, the tailgate 26 may have two module discharge openings 28, 30 in conjunction with the conveyor system. One opening 28 is larger in design to handle larger matter, such as mulch. The second opening 30 is of smaller design to handle finer particular matter such as sand or salt. The second opening 30 may be positioned inside the module for feed-gate operations. FIGS. 1 and 2 also show a spreader 32 operatively connected to the landscaper body 10. The spreader may include a removable spinner 34.

With continued reference to FIGS. 1 and 2, the truck bed 11 comprises a butterfly floor 36 arrangement. The butterfly door may have a first member and a second member. When the conveyor system is being utilized, such as in salting operations, the first and second members of the butterfly floor may be positioned, to a minimum position inside the body, to create a sloping side effect to the conveyor, best seen in FIG. 1. Alternately, the first and second members of the butterfly floor may be stowed into a maximum position outside the body and out of the way allowing use of the full capacity of the body. In this manner, an operator may be able to accomplish full discharge of the material contained in the truck bed 11 without “dumping.” When the conveyor system is not intended to be used, the first and second members may be maintained in a stowed position to provide a cover for the conveyor system and to provide for a substantially level truck bed floor.

It is also contemplated to be within the scope of the present invention for the landscaper body to comprise a mulch holding container with staked sides. The container may sit inside the truck bed 11 so as to extend the sides of the truck by three feet, or other height chosen in accordance with sound engineering judgment. This increased height enables the truck bed 11 to be filled with an increased amount of mulch. The container should be lightweight to enable easy installation and removal. The container may be made of steel, plastic or other material chosen with sound engineering judgment.

The landscaper body may have a separate water tank that can fit into the truck bed 11. The water tank may be the main storage unit for liquids or fertilizer and could be used to fill hand held units. A water hose attachment to spray off equipment or pavement or other object may also be included. A gas powered generator may be provided to fit into the landscaper body unit as an accessory. The landscaper body may have a storage tool box behind the cab integrated with the plastic body which may store hoses, hand tools, rope, etc. Storage may be provided over the cab wheel. Another option is to have a built in ladder or steps that enables the contractor to step up and look inside the truck bed 11. Still yet, another feature is to have a leaf shredder attached to the tailgate of the landscaper body with easy on and off leave shredding capability. A tow hitch may be included which would pull a leaf/wood shredder or a flat trailer. Further, a hydraulic circuit may be integrated into the landscaper body 10 such that contractors can “plug in” hydraulic attachments. Still yet, another option is to include an air compressor, positionable within the truck bed 11 so that air driven attachments may be utilized. The foregoing accessories and options may be selectively interchangeable depending upon the needs of the contractor.

Other features and advantages of the current invention include the floor which is adapted to provide two skids that can fit side by side. The width may be about 90 inches in width. Because the landscaper body loads and spreads salt, sand, dirt, and/or mulch, this eliminates the need for multiple units to perform the same job while simultaneously being economically advantageous. The landscaper body may have fold down sides which are flush such that the landscaper body is flat bed capable and multi-purpose, thus again saving time and energy. The floor may be made of any material chosen with sound engineering judgment, as long as it is tough for multi-purpose use, durable and long lasting. Such material thickness may be ten gauge.

The landscaper body may come in a variety of lengths such as 8, 9, 10 and 11 foot lengths. The cross-member-less design may include fold down sides, which may be 12 inches in height, although any size may be chosen with sound engineering judgment. The endless conveyor may be 34 inches in width. It may have a 67 H chain with a ¼ inch by ½ inch bar every third link. A 30.78 inch sprocket may be utilized with the chain center to center.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

1. A utility vehicle storage body, comprising:
a frame;
a generally planar frame bed juxtaposed to the frame;
a front body wall;
a rear body wall;
at least a first side operatively connected with respect to the frame, the at least a first side extending substantially along the entire length of the frame bed;
wherein the frame bed, front body wall, rear body wall and at least a first side define a body storage region; and,
at least a first frame bed member extending substantially along the entire length of the frame bed, the at least a first frame bed member being pivotally attached with respect to the frame, wherein the at least a first frame bed member is selectively moveable between a first minimum position interior to the body storage region and a second maximum position exterior to the body storage region.

2. The utility vehicle storage body of claim 1, further comprising:
a conveyor having first and second ends, the conveyor being operatively received within the body storage region, the conveyor extending proximate to and at least partially along the length of the frame bed.

3. The utility vehicle storage body of claim 2, wherein the conveyor extends substantially along the entire length of the frame bed.

4. The utility vehicle storage body of claim 2, wherein the rear body wall includes at least a first discharge opening, and,
wherein the first end of the conveyor is juxtaposed to the at least a first discharge opening.

5. The utility vehicle storage body of claim 4, wherein the at least a first discharge opening includes a moveable door, and,
wherein the door is selectively moveable between at least first and second open positions.

6. The utility vehicle storage body of claim 4, further comprising:
a spreader operatively connected with respect to the frame for use in the spreading associated materials from the storage body.

7. The utility vehicle storage body of claim 5, wherein the rear body wall has first and second sides, and,
wherein the first side is pivotally connected with respect to the frame, and,
wherein the second side is selectively releaseably attached with respect to the frame.

8. The utility vehicle storage body of claim 5, further comprises:
a hoist operatively connected to the storage body for use in raising the dump body with respect to an associated vehicle.

9. A utility vehicle storage body, comprising:
a frame;
a generally planar frame bed juxtaposed to the frame;
a front body wall;
a rear body wall; and,
at least a first side wall operatively connected with respect to the frame, the at least a first side wall extending substantially along the entire length of the frame bed, wherein the cross section of the at least a first side wall forms an angle A with respect to the cross section of the frame bed, wherein the at least a first side wall is selectively adjustable such that angle A is substantially between 0 and 180.

10. The utility vehicle storage body of claim 9, further comprising:
a conveyor having first and second ends, the conveyor being operatively connected with respect to the frame, the conveyor extending proximate to and at least partially along the length of the frame bed.

11. The utility vehicle storage body of claim 10, wherein the rear body wall includes at least a first discharge opening, and,
wherein the first end of the conveyor is juxtaposed to the at least a first discharge opening.

12. The utility vehicle storage body of claim 11, further comprising:
a spreader operatively connected with respect to the frame for use in the spreading associated materials from the storage body.

13. A vehicle, comprising:
a vehicle frame;
at least a first ground engaging wheel rotatably connected with respect to the vehicle frame;
an engine operatively received by the vehicle frame for use providing locomotion to the vehicle;
a utility storage body operatively connected to the vehicle frame, the utility storage body, comprising:
a body frame;
a generally planar body frame bed juxtaposed to the body frame;
a front body wall;
a rear body wall;
at least a first side wall operatively connected with respect to the frame, the at least a first side wall extending substantially along the entire length of the frame bed;
wherein the frame bed, front body wall, rear body wall and at least a first side define a body storage region; and,
at least a first frame bed member extending substantially along the entire length of the frame bed, the at least a first frame bed member being pivotally attached with respect to the frame, wherein the at least a first frame bed member is selectively moveable between a first minimum position interior to the body storage region and a second maximum position exterior to the body storage region.

14. The vehicle of claim 13, further comprising;
a hoist operatively connected between the vehicle frame and the body frame.

15. The vehicle of claim 14, further comprising:
a conveyor having first and second ends, the conveyor being operatively connected with respect to the body frame, the conveyor extending proximate to and at least partially along the length of the frame bed.

16. The vehicle of claim 15, wherein the rear body wall includes at least a first discharge opening, and,
wherein the first end of the conveyor is juxtaposed to the at least a first discharge opening.

17. The vehicle of claim 16, further comprising:
a spreader operatively connected with respect to the frame for use in the spreading associated materials from the storage body.
